(19) United States
(12) Patent Application Publication
(10) Pub. No.: US 2020/0014067 A1
(43) Pub. Date: Jan. 9, 2020

(54) Semisolid Electrolyte Solution, Semisolid Electrolyte, Semisolid Electrolyte Layer, Electrode, and Secondary Battery

(71) Applicant: Hitachi, Ltd., Chiyoda-ku, Tokyo (JP)

(72) Inventors: Suguru UEDA, Tokyo (JP); Jun KAWAJI, Tokyo (JP); Atsushi IIJIMA, Tokyo (JP); Atsushi UNEMOTO, Tokyo (JP); Akihide TANAKA, Tokyo (JP)

(21) Appl. No.: 16/484,669

(22) PCT Filed: Feb. 19, 2018
(86) PCT No.: PCT/JP2018/005661

§ 371 Date: Aug. 8, 2019

(30) Foreign Application Priority Data
Mar. 29, 2017 (JP) 2017-064156

(51) Int. Cl. H01M 10/0569; H01M 4/13; H01M 4/62; H01M 10/0525

(52) U.S. Cl. CPC H01M 10/0569; H01M 4/13; H01M 2300/0037; H01M 10/0525; H01M 2300/0045; H01M 4/62

(57) ABSTRACT

Aiming at improvement in the life and rate characteristic of the secondary battery, the semisolid electrolytic solution, the semisolid electrolyte layer, the electrode, and the secondary battery are provided. The semisolid electrolytic solution contains a solvation electrolyte salt, an ethereal solvent for forming a solvation ion liquid together with the solvation electrolyte salt, and a low-viscosity solvent. The mixture molar ratio of the ethereal solvent to the solvation electrolyte salt is in the range from ≥0.5 to ≤1.5. The mixture molar ratio of the low-viscosity solvent to the solvation electrolyte salt is in the range from ≥4 to ≤16.

### TECHNICAL FIELD

The present invention relates to a semisolid electrolytic solution, a semisolid electrolyte, a semisolid electrolyte layer, an electrode, and a secondary battery.

### BACKGROUND ART

Patent Literature 1 discloses the method for improvement of a battery life using glymes except tetraglyme for an electrolytic solution formed by mixing lithium salt with the glymes with high boiling/flash point as the technique using the organic solvent with high boiling/flash point as the electrolytic solution for the secondary battery.

### CITATION LIST

### Patent Literature

PTL 1: Japanese Unexamined Patent Application Publication No. 2015-216124

### SUMMARY OF INVENTION

### Technical Problem

The mixed solution of triglyme and lithium bis (fluorosulfonyl) imide as disclosed in Patent Literature 1 exhibits high viscosity, which may lower rate characteristic owing to low ionic conductance of lithium ion. Addition of the low viscosity organic solvent such as a carbonate based solvent for improving the ionic conductance may shorten the secondary battery life depending on a mixing ratio between the mixed solution and the low-viscosity organic solvent.

It is an object of the present invention to improve the life and the rate characteristic of the secondary battery.

### Solution to Problem

The characteristic of the present invention for solving the above-described problem will be described hereinafter.

The semisolid electrolytic solution contains a solvation electrolyte salt, an ethereal solvent for forming a solvation ion liquid together with the solvation electrolyte salt, and a low-viscosity solvent. A mixture molar ratio of the ethereal solvent to the solvation electrolyte salt is in a range from 0.5 to 1.5. A mixture molar ratio of the low-viscosity solvent to the solvation electrolyte salt is in a range from 4 to 16.

### Advantageous Effects of Invention

The present invention allows improvement of the life and the rate characteristic of the secondary battery. Problems, structures, and advantageous effects other than those described above will be clarified by explanations to be described below.

### BRIEF DESCRIPTION OF DRAWINGS

FIG. 1 is a sectional view of an all-solid battery according to an embodiment of the present invention.

FIG. 2 shows charging/discharging curves each in initial charging/discharging derived from examples and comparative examples.

FIG. 3 shows the respective rate characteristics of batteries according to examples and a comparative example.

FIG. 4 shows results derived from examples and comparative examples.

### DESCRIPTION OF EMBODIMENT

An embodiment according to the present invention will be described referring to the drawings. The following explanation represents specific examples of the present invention in a non-restricted manner. It is possible for those who skilled in the art to make arbitrary variations and modifications so long as they do not deviate from the technical idea disclosed in the specification. Throughout the drawings for explaining the present invention, the components with the same functions are designated with the same codes, and repetitive explanations thereof may be omitted.

The explanation will be made with respect to a lithium-ion secondary battery as an example of the secondary battery. The lithium-ion secondary battery is an electrochemical device capable of storing or using electric energy by occlusion/release of lithium ions in/from the electrode in the nonaqueous electrolyte. It may be differently called as a lithium-ion battery, a nonaqueous electrolyte secondary battery, and a nonaqueous electrolytic solution secondary battery. The present invention is applicable to any of the above-described batteries. The technical idea of the present invention is applicable not only to the lithium-ion secondary battery, but also to a sodium-ion secondary battery, a magnesium-ion secondary battery, an aluminum-ion secondary battery, and the like.

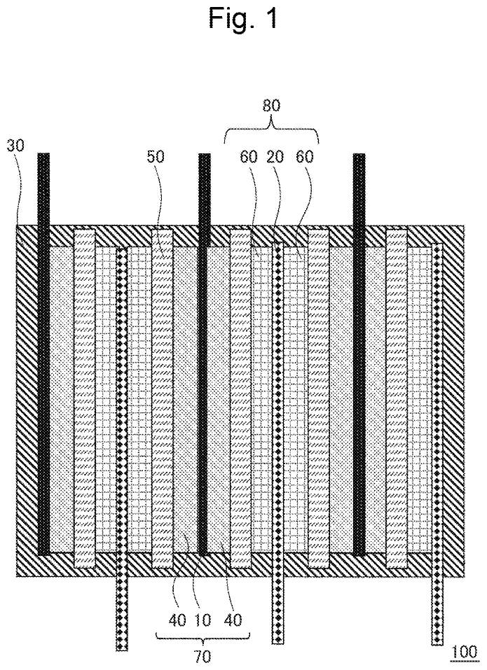

FIG. 1 is a sectional view of the secondary battery according to an embodiment of the present invention. As FIG. 1 shows, a secondary battery 100 includes a positive electrode 70, a negative electrode 80, a battery case 30, and a semisolid electrolyte layer 50. The battery case 30 accommodates the semisolid electrolyte layers 50, the positive electrodes 70, and the negative electrodes 80. The material for making the battery case 30 is selectable from those with corrosion resistance against the nonaqueous electrolyte such as aluminum, stainless steel, and nickel plated steel. FIG. 1 shows the stack type secondary battery. However, the technical idea of the present invention is applicable to the wound type secondary battery.

Electrode elements each constituted by the positive electrode 70, the semisolid electrolyte layer 50, and the negative electrode 80 are stacked in the secondary battery 100. The positive electrode 70 includes a positive electrode current collector 10 and positive electrode mixture layers 40. The positive electrode mixture layers 40 are formed on both surfaces of the positive electrode current collector 10, respectively. The negative electrode 80 includes a negative electrode current collector 20 and negative electrode mixture layers 60. The negative electrode mixture layers 60 are formed on both surfaces of the negative electrode current collector 20, respectively. The positive electrode current collector 10 and the negative electrode current collector 20 protrude outside the battery case 30. The protruding positive current collectors 10 may be joined, and the protruding negative current collectors 20 may be joined through the ultrasonic joining process, respectively so that parallel connections are established in the secondary battery 100. It is possible to form a bipolar secondary battery by making electrical series connections in the secondary battery 100. The positive electrode 70 or the negative electrode 80 may be referred to as an electrode. The positive electrode mixture layer 40 or the negative electrode mixture layer 60 may be referred to as an electrode mixture layer. The positive electrode current collector 10 or the negative electrode current collector 20 may be referred to as an electrode current collector.

The positive electrode mixture layer 40 includes a positive electrode active material, a positive electrode conductive agent intended to improve conductivity of the positive electrode mixture layer 40, and a positive electrode binder for binding those elements. The negative electrode mixture layer 60 includes a negative electrode active material, a negative electrode conductive agent intended to improve conductivity of the negative electrode mixture layer 60, and a negative electrode binder for binding those elements. The semisolid electrolyte layer 50 includes a semisolid electrolyte binder and a semisolid electrolyte. The semisolid electrolyte includes inorganic particles and a semisolid electrolytic solution. The positive electrode active material or the negative electrode active material may be referred to as an electrode active material. The positive electrode conductive agent or the negative electrode conductive agent may be referred to as an electrode conductive agent. The positive electrode binder or the negative electrode binder may be referred to as an electrode binder.

The semisolid electrolyte layer 50 is a material made by mixing oxide particles such as SiO₂ with the semisolid electrolytic solvent dissolved with lithium salt. The semisolid electrolyte layer 50 is characterized that no electrolytic solution with fluidity is contained, thus suppressing the electrolytic solution from leaking out. The semisolid electrolyte layer 50 serves as a medium for transmitting lithium ions between the positive electrode 70 and the negative electrode 80, and further serves as an electron insulator so as to prevent short-circuit between the positive electrode 70 and the negative electrode 80.

In order to fill the semisolid electrolyte into a micro-pore of the electrode mixture layer, the semisolid electrolyte may be added to the electrode mixture layer to be absorbed by the micro-pores of the electrode mixture layer so as to retain the semisolid electrolyte. At the timing as described above, the semisolid electrolytic solution may be retained by using particles of the electrode active material, and the electrode conductive agent in the electrode mixture layer without requiring inorganic particles contained in the semisolid electrolyte layer. In another method of filling the semisolid electrolytic solution into the micro-pores of the electrode mixture layer, a slurry is prepared by mixing the semisolid electrolyte, the electrode active material, and the electrode binder so that the electrode mixture layer is applied onto the electrode current collector together with the slurry.

### <Electrode Conductive Agent>

Such material as Ketjenblack and acetylene black may be used for making the electrode conductive agent, which is not limited to those described above.

### <Electrode Binder>

Such material as styrene-butadiene rubber, carboxymethyl cellulose, polyvinylidene fluoride (PVDF), and mixtures thereof may be used for making the electrode binder, which is not limited to those described above.

### <Positive Electrode Active Material>

In a charging process, the positive electrode active material allows desorption of a lithium ion, and, in a discharging process, allows insertion of the lithium ion desorbed from the negative electrode active material in the negative electrode mixture layer. It is preferable to use lithium composite oxide which contains transition metal as the material for making the positive electrode active material in the non-restricted manner, for example, LiCoO₂, LiNiO₂, LiMn₂O₄, LiMnO₃, LiMn₂O₃, LiMnO₂, Li₄Mn₅O₁₂, LiMn₂₋ₓMₓO₂ (M=Co, Ni, Fe, Cr, Zn, Ta, x=0.01 to 0.2), Li₂Mn₃MO₈ (M═Fe, Co, Ni, Cu, Zn), Li₁₋ₓAxMn₂O₄ (A=Mg, B, Al, Fe, Co, Ni, Cr, Zn, Ca, x=0.01 to 0.1), LiNi₁₋ₓMxO₂ (M=Co, Fe, Ga, x=0.01 to 0.2), LiFeO₂, Fe₂(SO₄)₃, LiCo₁₋ₓMₓO₂ (M=Ni, Fe, Mn, x=0.01 to 0.2), LiNi₁₋ₓMₓO₂ (M=Mn, Fe, Co, Al, Ga, Ca, Mg, x=0.01 to 0.2), Fe(MoO₄)₃, FeF₃, LiFePO₄, and LiMnPO₄.

### <Positive Electrode Current Collector 10>

Such material as aluminum foil with thickness of 10 to 100 μm, perforated aluminum foil with thickness of 10 to 100 μm, and the hole with pore size of 0.1 to 10 mm, expanded metal, and foamed metal plate may be used for making the positive electrode current collector 10. Besides the aluminum, such material as stainless steel, and titanium may be employed. It is possible to use arbitrary material for making the positive electrode current collector 10 without being limited to the material, shape, and manufacturing method so long as the change, for example, dissolution and oxidation does not occur in using the secondary battery.

### <Positive Electrode 70>

The positive electrode 70 may be produced by making a positive electrode slurry formed by mixing the positive electrode active material, the positive electrode conductive agent, the positive electrode binder, and the organic solvent, making the resultant slurry adhered to the positive electrode current collector 10 through the doctor blade process, the dipping process or the spray process, and drying the organic solvent for press molding with a roll press machine. Execution of the process from coating to drying multiple times allows the multiple positive electrode mixture layers 40 to be stacked on the positive electrode current collector 10. Preferably, the thickness of the positive electrode mixture layer 40 is equal to or larger than an average particle size of the positive electrode active material. This is because the thickness of the positive electrode mixture layer 40 which is smaller than the average particle size of the positive electrode active material deteriorates the electron conductivity between the adjacent positive electrode active materials.

### <Negative Electrode Active Material>

In the discharging process, the negative electrode active material allows desorption of the lithium ion, and, in the charging process, allows insertion of the lithium ion desorbed from the positive electrode active material in the positive electrode mixture layer 40. It is preferable to use the material for making the negative electrode active material in the non-restricted manner, for example, carbon based material (for example, graphite, easily graphitizable carbon material, amorphous carbon material), conductive polymer material (for example, polyacene, polyparaphenylene, polyaniline, polyacetylene), lithium composite oxide (for example, lithium titanate: Li₄Ti₅O₁₂), metallic lithium, and metal to be alloyed with lithium (for example, aluminum, silicon, tin).

### <Negative Electrode Current Collector 20>

Such material as a copper foil with thickness of 10 to 100 μm, a perforated copper foil with thickness of 10 to 100 μm, and the hole with pore size of 0.1 to 10 mm, the expanded metal, and the foamed metal plate may be used for making the negative electrode current collector 20. Besides the copper, such material as stainless steel, titanium, and nickle may be employed. It is possible to use an arbitrary type of the negative electrode current collector 20 without being limited to the material, shape, and manufacturing method.

### <Negative Electrode 80>

The negative electrode 80 may be produced by making a negative electrode slurry formed by mixing the negative electrode active material, the negative electrode conductive agent, and the organic solvent that contains a small amount of water, making the resultant slurry adhered to the negative electrode current collector 20 through the doctor blade process, the dipping process or the spray process, and drying the organic solvent for press molding with the roll press machine. Execution of the process from coating to drying multiple times allows the multiple negative electrode mixture layers 60 to be stacked on the negative electrode current collector 20. Preferably, the thickness of the negative electrode mixture layer 60 is equal to or larger than the average particle size of the negative electrode active material. This is because the thickness of the negative electrode mixture layer 60 smaller than the average particle size of the negative electrode active material deteriorates the electron conductivity between the adjacent negative electrode active materials.

### <Inorganic Particle>

Preferably, the inorganic particle (particle) is an insulating particle, and insoluble in the organic solvent or the semisolid electrolytic solution that contains ion liquid from the point view of electrochemical stability. It is preferable to use silica (SiO₂) particle, y-alumina (Al₂O₃) particle, ceria (CeO₂) particle, and zirconia (ZrO₂) particle. It is also possible to use other known metallic oxide particles.

Preferably, the average primary particle size of the inorganic particles ranges from 1 nm to 10 μm as the retention of the semisolid electrolytic solution is thought to be proportional to the specific surface area of the inorganic particle. If the average particle size is larger than 10 μm, the inorganic particles fail to appropriately retain sufficient amount of the semisolid electrolytic solution, leading to difficulty in formation of the semisolid electrolyte. If the average particle size is smaller than 1 nm, the surface force between the inorganic particles is intensified to facilitate aggregation of the particles, leading to difficulty in formation of the semisolid electrolyte. The average primary particle size of the inorganic particles ranging from 1 nm to 50 nm is more preferable, and ≥1 nm to 10 nm is further preferable. The average particle size may be measured using a transmission electron microscope (TEM).

### <Semisolid Electrolytic Solution>

The semisolid electrolytic solution contains a semisolid electrolyte solvent, a low-viscosity solvent, an arbitrary type of additive, and an arbitrary type of electrolyte salt. The semisolid electrolyte solvent contains a mixture (complex) of an ethereal solvent exhibiting similar property to that of the ion liquid, and a solvation electrolyte salt. The ion liquid as a compound which dissociates to give cation and anion at a room temperature retains the liquid state. The ion liquid may be referred to as ionic liquid, low melting point molten salt, or normal temperature molten salt. From a point of view of stability in the atmosphere and heat resistance in the secondary battery, preferably, the semisolid electrolyte solvent has low volatility, more specifically, the vapor pressure equal to or lower than 150 Pa at the room temperature.

If the electrode contains the semisolid electrolytic solution, preferably, the content of the semisolid electrolytic solution in the electrode is ≥20 vol % and ≤40 vol %. If the content of the semisolid electrolytic solution is lower than 20%, an ion conduction path inside the electrode is not formed sufficiently, which may deteriorate the rate characteristic. If the content of the semisolid electrolytic solution is equal to or higher than 40%, leakage of the semisolid electrolytic solution from the electrode may occur.

The ethereal solvent and the solvation electrolyte salt constitute the solvation ion liquid. It is possible to use the known glyme exhibiting the similar property to that of the ion liquid (R—O(CH₂CH₂O)n-R′ (R, R′: saturated hydrocarbon, n: integer) as a general term of symmetric glycol diether) for the ethereal solvent. From a point of view of ion conductivity, it is preferable to use tetraglyme (tetraethylene dimethyl glycol, G4), triglyme (triethyleneglycol dimethyl ether, G3), pentaglyme (pentaethylene glycol dimethyl ether, G5), hexaglyme (hexaethylene glycol dimethyl ether, G6). Any one of the above-described glymes may be used alone, or arbitrary combination of multiple glymes may also be used. It is possible to suitably use crown ether (general term of macrocyclic ether expressed as (—CH₂—CH₂—O)n (n:integer)) for the ethereal solvent. Specifically, it is possible to use 12-crown-4, 15-crown-5, 18-crown-6, dibenzo-18-crown-6 in the non-restricted manner. Any one of the crown ethers may be used alone, or arbitrary combination of multiple types of crown ether may be used. It is possible to use the tetraglyme and the triglyme among glymes as they are capable of forming the complex structure with the solvation electrolyte salt as the lithium salt.

It is possible to use an imide salt such as LiFSI, LiTFSI, and LiBETI as the solvation electrolyte salt in the non-restricted manner. It is possible to use the mixture of ethereal solvent and solvation electrolyte salt alone or in arbitrary combination of multiple mixtures as the semisolid electrolyte solvent.

It is preferable to use, for example, liPF₆, LiBF₄, LiCIO₄, LiCF₃SO₃, LiCF₃CO₂, LiAsF₆, LiSbF₆, lithium bis-oxalate borate (LiBOB), LiFSI, LiTFSI, LiBTFI as the electrolyte salt. Any one of those electrolyte salts may be used alone, or combination of multiple electrolyte salts may also be used.

### <Low-Viscosity Solvent>

The viscosity of the semisolid electrolytic solution may be lowered by allowing the low-viscosity solvent to be contained in the semisolid electrolytic solution. It is possible to use the organic solvent such as propylene carbonate, ethylene carbonate, dimethyl carbonate, the ion liquid such as N,N-diethyl-N-methyl-N-(2-methoxyethy) ammonium bis (trifluoromethane sulfonyl) imide, and hydrofuluoroethers (for example, 1,1,2,2-tetrafluoroethyl-12,2,3,3-tetrafluoropropyl ether) as the low-viscosity solvent. Preferably, the low-viscosity solvent has the viscosity lower than that of the mixed solution of the ethereal solvent and the solvation electrolyte salt. It is preferable not to largely collapse the solvation structure of the ethereal solvent and the solvation electrolyte salt. Specifically, it is possible to use the solvent with the donor number substantially the same as or smaller than that of the ethereal solvent, for example, glyme, the crown ether or the like, that is, propylene carbonate, ethylene carbonate, acetonitrile, dichloroethane, dimethyl carbonate, 1,1,2,2-tetrafluoroethyl-12,2,3,3-tetrafluoropropyl ether. Any one of the above-described low-viscosity solvents may be used alone, or arbitrary combination of multiple solvents may also be used. It is preferable to use the ethylene carbonate, and more preferable to use propylene carbonate. Because of high boiling point of the ethylene carbonate and the propylene carbonate, they are unlikely to volatilize in the case that the low-viscosity solvent is contained in the electrode, and hardly influenced by the composition change in the semisolid electrolytic solution owing to volatilization.

### <Mixing Ratio>

Preferably, the mixing molar ratio of the ethereal solvent to the solvation electrolyte salt is in the range from ≥0.5 to ≤1.5, more preferably, from ≥0.5 to ≤1.2, and further preferably, from ≥0.5 to ≤0.8. The mixing ratio set in the above-described range allows all the ethereal solvent introduced in the semisolid electrolytic solution to form the solvation structure with the solvation electrolyte salt so as to suppress the oxidation-reduction decomposition of the ethereal solvent on the electrode. Preferably, the mixing molar ratio of the low-viscosity solvent to the electrolyte salt is in the range from ≥4 to ≤16, more preferably, from ≥4 to ≤12, and further preferably, from ≥4 to ≤6. The mixing ratio set in the above-described range allows the viscosity of the semisolid electrolytic solution to be sufficiently lowered, thus improving the rate characteristic.

### <Additive>

The use of a small amount of the low-viscosity solvent as the additive is allowable even if it fails to satisfy the above-described condition of the donor number. Improvement of the rate characteristic and the life of the secondary battery can be expected by containing the additive in the semisolid electrolytic solution. Preferably, the amount of the added additive is ≤30 mass % to the weight of the semisolid electrolytic solution, and especially, ≤10 mass % is further preferable. Introduction of the additive is not expected to largely collapse the solvation structure among the glymes, the crown ethereal solvent, and the solvation electrolyte salt so long as the added amount of the additive is 30 mass %. It is preferable to use vinylene carbonate and fluoroethylene carbonate as the additive. Any one of those additives may be used alone, or arbitrary combination of multiple additives may also be used.

### <Semisolid Electrolyte Binder>

A fluorine based resin is suitably used as the semisolid electrolyte binder. Polytetrafluoroethylene (PTFE) is suitably used as the fluorine based resin. The use of PTFE improves contactness between the semisolid electrolyte layer 50 and the electrode current collector, resulting in improved battery performance.

### <Semisolid Electrolyte>

The semisolid electrolyte is formed by allowing the semisolid electrolytic solution to be carried (held) by the inorganic particle. In one of the semisolid electrolyte producing methods, the semisolid electrolytic solution and inorganic particles are mixed in a prescribed volume ratio, to which the organic solvent such as methanol is added and mixed so that the semisolid electrolyte slurry is prepared. The thus prepared slurry is spread on a petri dish to distil the organic solvent for obtaining powdered semisolid electrolyte.

### <Semisolid Electrolyte Layer 50>

The method of producing the semisolid electrolyte layer 50 may be performed through the process in which the powdered semisolid electrolyte is compression molded into pellets using the molding die, and the process in which the semisolid electrolyte binder is added to the powdered semisolid electrolyte so as to be mixed, and then formed into the sheet. The highly flexible semisolid electrolyte layer 50 (electrolyte sheet) may be produced by adding the powdered electrolyte binder to the semisolid electrolyte so as to be mixed. Alternatively, the semisolid electrolyte layer 50 may be produced by adding the solution of the binding agent having the semisolid electrolyte binder dissolved in the dispersant solvent to the semisolid electrolyte so as to be mixed, and distilling the dispersant solvent. It is possible to produce the semisolid electrolyte layer 50 through the coating and drying process on the electrode. Preferably, the content of the semisolid electrolytic solution in the semisolid electrolyte layer 50 ranges from ≥70 vol % to ≤90 vol %. If the content of the semisolid electrolytic solution is higher than 70 vol %, interface resistance between the electrode and the semisolid electrolyte layer 50 may be markedly increased. If the content of the semisolid electrolytic solution is higher than 90 vol %, the semisolid electrolytic solution may leak out from the semisolid electrolyte layer 50.

A microporous membrane may be added to the semisolid electrolyte layer 50. It is possible to use a polyolefin such as polyethylene and polypropylene, and glass fiber as the microporous membrane.

It is also possible to use the microporous membrane which contains no semisolid electrolytic solution as the semisolid electrolyte layer 50 for isolating the positive electrode 70 and the negative electrode 80. In this case, the semisolid electrolytic solution is poured into the battery case 30 so as to be filled into the secondary battery 100, especially, the microporous membrane. The insulating layer may be made by coating the slurry having the binder contained in inorganic oxide particles onto the electrode or the microporous membrane. The inorganic oxide particle may include the silica particle, γ-alumina particle, ceria particle, zirconia particle and the like. Any one of the above-described materials may be used alone, or arbitrary combination of multiple materials may also be used. The above-described semisolid electrolyte binder may be used as the binder.

The present invention will be further described in detail in reference to the following examples. However, the present invention is not limited to those described hereinafter.

### EXAMPLE 1

### <Semisolid Electrolytic Solution>

The semisolid electrolytic solution was produced by preparing the mixture of LiTFSI, G4 and PC in a molar ratio of 1:1:4 in a glass bottle while being stirred and dissolved using a magnetic stirrer.

### <Negative Electrode 80>

A slurried solution was produced by mixing graphite (amorphous coated, average particle size: 10 μm), polyvinylidene fluoride (PVDF), conductive auxiliary agent (acetylene black) in a weight ratio of 88:10:2, and adding N-methyl-2-pyrolidone to the mixture so as to be mixed. The produced slurry was coated onto the current collector composed of a SUS foil with thickness of 10 μm using the doctor blade, and dried at 80° C. for 2 hours or longer. The slurry coating amount was adjusted so that the weight of the negative electrode mixture layer 60 per cm² after drying became 8 mg/cm². The dried electrode was pressurized until the density became 1.5 g/cm³, and punched with φ3 mm to obtain the negative electrode 80.

### <Secondary Battery>

The produced negative electrode 80 was dried at 100° C. for 2 hours or longer, and then moved to the inside of a glove box filled with argon. An appropriate amount of the semisolid electrolytic solution was added to the negative electrode 80 and a polypropylene separator with thickness of 30 μm, into which the electrolytic solution was infiltrated. The negative electrode 80 disposed on one surface of the separator, and the lithium metal disposed on the other surface were put into a coin type battery cell holder with size 2032. The holder was sealed with a caulking machine to obtain the secondary battery 100 according to Example 1.

### EXAMPLE 2

The secondary battery 100 was produced in the similar way to Example 1 except the mixing molar ratio of LiTFSI, G4 and PC for the semisolid electrolytic solution set to 1:0.8:5.

### EXAMPLE 3

The secondary battery 100 was produced in the similar way to Example 1 except the mixing molar ratio of LiTFSI, G4 and PC for the semisolid electrolytic solution set to 1:0.6:5.

### EXAMPLE 4

The secondary battery 100 was produced in the similar way to Example 1 except the mixing molar ratio of LiTFSI, G4 and PC for the semisolid electrolytic solution set to 1:1.2:5.

### EXAMPLE 5

The secondary battery 100 was produced in the similar way to Example 1 except the mixing molar ratio of LiTFSI, G4 and PC for the semisolid electrolytic solution set to 1:1:8.

### EXAMPLE 6

The secondary battery 100 was produced in the similar way to Example 1 except the mixing molar ratio of LiTFSI, G4 and PC for the semisolid electrolytic solution set to 1:0.8:8.

### EXAMPLE 7

The secondary battery 100 was produced in the similar way to Example 1 except the mixing molar ratio of LiTFSI, G4 and PC for the semisolid electrolytic solution set to 1:0.6:8.

### EXAMPLE 8

The secondary battery 100 was produced in the similar way to Example 1 except the mixing molar ratio of LiTFSI, G4 and PC for the semisolid electrolytic solution set to 1:1.2:8.

### EXAMPLE 9

The secondary battery 100 was produced in the similar way to Example 1 except the use of LiFSI as the electrolyte salt for the semisolid electrolytic solution in place of LiTFSI.

### EXAMPLE 10

The secondary battery 100 was produced in the similar way to Example 1 except addition of 10 mass % of vinylene carbonate to the semisolid electrolytic solution.

### EXAMPLE 11

The secondary battery 100 was produced in the similar way to Example 1 except the use of triglyme (G3) for the semisolid electrolytic solution in place of tetraglyme (G4).

### EXAMPLE 12

The secondary battery 100 was produced in the similar way to Example 11 except the mixing molar ratio of LiTFSI, G3 and PC for the semisolid electrolytic solution set to 1:0.75:5.

### EXAMPLE 13

The secondary battery 100 was produced in the similar way to Example 11 except the mixing molar ratio of LiTFSI, G3 and PC for the semisolid electrolytic solution set to 1:0.5:5.

### EXAMPLE 14

The secondary battery 100 was produced in the similar way to Example 11 except the mixing molar ratio of LiTFSI, G3 and PC for the semisolid electrolytic solution set to 1:1.25:5.

### EXAMPLE 15

The secondary battery 100 was produced in the similar way to Example 11 except the mixing molar ratio of LiTFSI, G3 and PC for the semisolid electrolytic solution set to 1:1.5:5.

### EXAMPLE 16

The secondary battery 100 was produced in the similar way to Example 11 except the mixing molar ratio of LiTFSI, G4 and PC for the semisolid electrolytic solution set to 1:1:12.

### EXAMPLE 17

The secondary battery 100 was produced in the similar way to Example 11 except the mixing molar ratio of LiTFSI, G4 and PC for the semisolid electrolytic solution set to 1:1:16.

### EXAMPLE 18

The secondary battery 100 was produced in the similar way to Example 1 except the use of 12-crown-4-ether for the semisolid electrolytic solution in place of G4.

### EXAMPLE 19

The secondary battery 100 was produced in the similar way to Example 1 except the use of ethylene carbonate for the semisolid electrolytic solution in place of PC.

### EXAMPLE 20

The semisolid electrolyte was produced in the following procedure using the semisolid electrolyte layer 50 in place of the separator according to Example 1.

### <Semisolid Electrolyte Layer 50>

The semisolid electrolytic solution was produced by mixing LiTFSI, G4 and PC. The semisolid electrolytic solution and SiO₂ nanoparticles (particle size: 7 nm) were mixed in volume fraction of 80:20 inside the glove box in the argon atmosphere. Methanol was added to the mixture, and then stirred for 30 minutes using the magnet stirrer. The resultant mixed liquid was spread onto the petri dish to distil methanol so as to obtain powdered semisolid electrolyte. PTFE powder was added to the obtained powder by 5 mass %. The resultant mixture was elongated under pressure while being mixed well to obtain the semisolid electrolyte layer 50 in the molar ratio of LiTFSI, G4 and PC set to 1:1:4 in the form of the sheet with thickness of approximately 200 μm.

### <Secondary Battery 100>

The obtained semisolid electrolyte layer 50 was punched with size of φ15 mm. Then the negative electrode 80 produced in the similar way to Example 1 while being disposed on one surface of the semisolid electrolyte layer 50, and the lithium metal disposed on the other surface were put into the coin type battery cell holder with size 2032. The holder was sealed with the caulking machine to obtain the secondary battery 100.

### Embodiment 21

The secondary battery 100 was produced in the similar way to Example 20 except the mixing molar ratio of LiTFSI, G4 and PC for the semisolid electrolyte layer 50 set to 1:0.8:5.

### Embodiment 22

The secondary battery 100 was produced in the similar way to Example 21 except addition of 10 mass % of vinylene carbonate to the semisolid electrolyte layer 50.

### Embodiment 23

The secondary battery 100 was produced in the similar way to Example 21 except the use of LiFSI as the lithium salt used for the semisolid electrolyte layer 50 in place of LiTFSI.

### Embodiment 24

### <Positive Electrode 70>

A slurried solution was prepared by mixing the positive electrode active material LiNiMnCoO2, polyvinylidene fluoride (PVDF), and the conductive auxiliary agent (acetylene black) in a weight ratio of 84:9:7, and adding N-methyl-2-pyrolidone to the mixture so as to be further mixed. The prepared slurry was coated onto the current collector composed of the SUS foil with thickness of 10 μm using the doctor blade, and dried at 80° C. for 2 hours or longer. The slurry coating amount was adjusted so that the weight of the positive electrode mixture layer 40 per cm² after drying became 18 mg/cm². It was pressurized until the density after drying became 2.5 g/cm³, and punched with φ13 mm to produce the positive electrode 70.

### <Secondary Battery 100>

The secondary battery 100 was produced in the similar way to Example 1 except the use of the positive electrode 70 according to this example in place of the lithium metal according to Example 1.

### EXAMPLE 25

The secondary battery 100 was produced in the similar way to Example 24 except the mixing molar ratio of LiTFSI, G4 and PC for the semisolid electrolyte layer 50 set to 1:0.8:5.

### EXAMPLE 26

The secondary battery 100 was produced in the similar way to Example 24 except addition of 10 mass % of vinylene carbonate to the semisolid electrolyte layer 50.

### EXAMPLE 27

The secondary battery 100 was produced in the similar way to Example 24 except the use of LiFSI as the lithium salt used for the semisolid electrolyte layer 50 in place of LiTFSI.

### EXAMPLE 28

The secondary battery of 2-series bipolar type was produced using the semisolid electrolyte layer 50 produced in the procedure according to Example 20, the positive electrode 70 produced in the procedure according to Example 24, and the negative electrode 80. The single sheet of stainless foil having one surface coated with the positive electrode 70, and the other surface coated with the negative electrode 80 was pressed, and punched in size φ13 to provide 2 bipolar electrodes. Two semisolid electrolyte layers 50 were prepared while having the periphery applied with a doughnut type polyimide tape with external dimension of 18 mm, and inner diameter of 14 mm for insulation. The body formed by sequentially laminating the positive electrode 70, the semisolid electrolyte layer 50, the bipolar electrode, the semisolid electrolyte layer 50, and the negative electrode 80 was put into the coin type battery cell container, and sealed with the caulking machine to obtain the bipolar secondary battery 100. In this case, the negative electrode 80 and the positive electrode 70 constituting the bipolar electrode were configured to face the negative electrode 80 and the positive electrode 70, respectively via the joined semisolid electrolyte layers 50.

### EXAMPLE 29

The secondary battery 100 was produced in the similar way to Example 28 except the use of G3 for the semisolid electrolyte layer 50 in place of G4.

### EXAMPLE 30

The secondary battery 100 was produced in the similar way to Example 28 except the mixing molar ratio of LiTFSI, G3 and PC for the semisolid electrolyte layer 50 set to 1:0.75:5.

### COMPARATIVE EXAMPLE 1

The secondary battery 100 was produced in the similar way to Example 1 except the mixing molar ratio of LiTFSI, G4 and PC for the semisolid electrolyte layer 50 set to 1:1:0.

### COMPARATIVE EXAMPLE 2

The secondary battery 100 was produced in the similar way to Example 1 except the mixing molar ratio of LiTFSI, G4 and PC for the semisolid electrolyte layer 50 set to 1:0:3.

### COMPARATIVE EXAMPLE 3

The secondary battery 100 was produced in the similar way to Example 1 except the mixing molar ratio of LiTFSI, G4 and PC for the semisolid electrolyte layer 50 set to 1:0:4.

### COMPARATIVE EXAMPLE 4

The secondary battery 100 was produced in the similar way to Example 1 except the mixing molar ratio of LiTFSI, G4 and PC for the semisolid electrolyte layer 50 set to 1:0:8.

### COMPARATIVE EXAMPLE 5

The secondary battery 100 was produced in the similar way to Example 1 except the mixing molar ratio of LiTFSI, G4 and PC for the semisolid electrolyte layer 50 set to 1:1:1.

### COMPARATIVE EXAMPLE 6

The secondary battery 100 was produced in the similar way to Example 1 except the mixing molar ratio of LiTFSI, G4 and PC for the semisolid electrolyte layer 50 set to 1:1:2.

### COMPARATIVE EXAMPLE 7

The secondary battery 100 was produced in the similar way to Example 20 except the mixing molar ratio of LiTFSI, G4 and PC for the semisolid electrolyte layer 50 set to 1:1:0.

### COMPARATIVE EXAMPLE 8

The secondary battery 100 was produced in the similar way to comparative example 7 except the use of LiFSI as the lithium salt for the semisolid electrolyte layer 50 in place of LiTFSI.

### COMPARATIVE EXAMPLE 9

The secondary battery 100 was produced in the similar way to Example 1 except the use of y-butyl lactone (GBL) for the semisolid electrolyte layer 50 in place of PC.

### COMPARATIVE EXAMPLE 10

The secondary battery 100 was produced in the similar way to Example 1 except the use of trimethyl phosphate (TMP) for the semisolid electrolyte layer 50 in place of PC.

### COMPARATIVE EXAMPLE 11

The secondary battery 100 was produced in the similar way to Example 1 except the use of triethyl phosphate (TEP) for the semisolid electrolyte layer 50 in place of PC.

### COMPARATIVE EXAMPLE 12

The secondary battery 100 was produced in the similar way to Example 1 except the mixing molar ratio of LiTFSI, G4 and PC for the semisolid electrolyte layer 50 set to 1:2:5.

### <Evaluation of Battery Capacity in Examples and Comparative Examples>

### (1) Graphite-Lithium Metal Battery

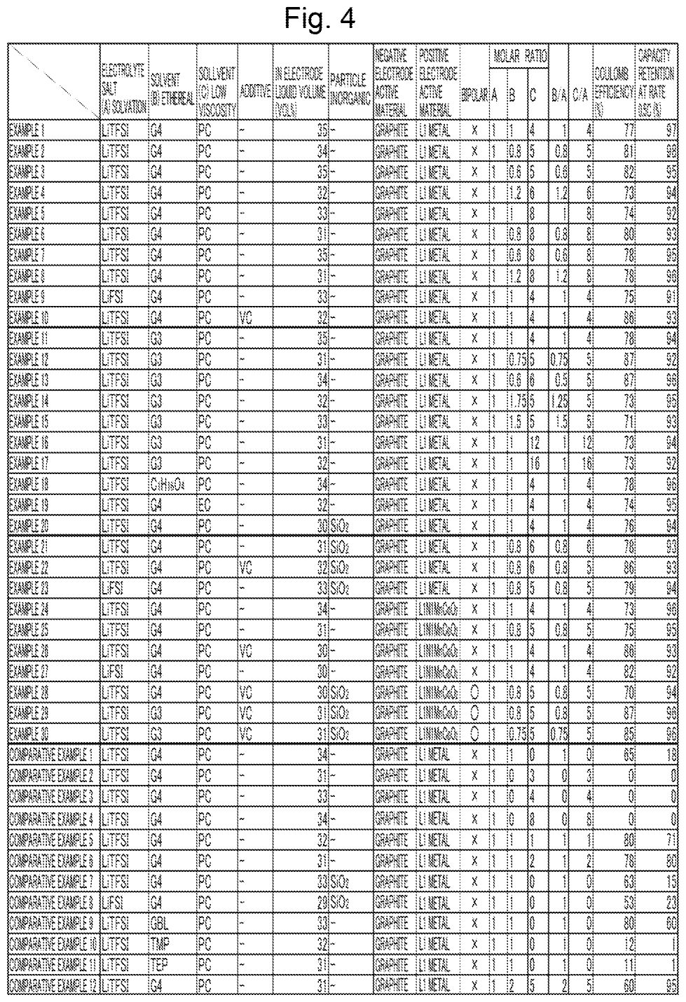

Using the coin type secondary batteries 100 in the corresponding example and the corresponding comparative example, measurement was conducted at 25° C. The battery was charged at 0.05 C rate using a potentiostat of No. 1480 manufactured by Solartron Analytical. After an elapse of 1 hour for deactivation in the open circuit state, it was discharged at 0.05 C rate. Upon charging/discharging, it was charged with constant current at 0.05 C rate until the potential across the electrodes of the secondary battery 100 reached 0.005 V. Thereafter, it was discharged at the potential of 0.005 V until the current value reached 0.005 C rate (constant current/constant voltage charging). Upon discharging, it was discharged with constant current at 0.05 C rate up to 1.5 V (constant current discharging). FIG. 4 shows measurement results.

### (2) Graphite-LiNiMnCoO₂ Battery

Using the coin type secondary battery 100 according to the corresponding example, measurement was conducted at 25° C. The measurement procedure is substantially the same as the one for the battery as described in (1) except the point as follows. Upon charging/discharging, it was charged with constant current at 0.05 C rate until the potential across the electrodes of the secondary battery 100 reached 4.2 V, and discharged at the potential of 4.2 V until the current value reached 0.005 C rate. Upon discharging, it was discharged with constant current at 0.05 C rate up to 2.7 V. FIG. 4 shows measurement results.

### (3) Graphite-LiNiMnCoO₂ Bipolar Battery

Using the coin type secondary battery 100 according to the corresponding example, measurement was conducted at 25° C. The measurement procedure is substantially the same as the one for the battery as described in (1) except the point as follows. Upon charging/discharging, the battery was charged with constant current at 0.05 C rate until the potential across the electrodes of the secondary battery 100 reached 8.0 V, and discharged at the potential of 8.0 V until the current value reached 0.005 C rate. Upon discharging, it was discharged with constant current at 0.05 C rate up to 6.0 V. FIG. 4 shows measurement results.

### <Evaluation of Rate Characteristics in Examples and Comparative Examples>

Using the coin type secondary batteries 100 according to the examples and the comparative examples, measurement was conducted. After execution of the initial charging/discharging in the above-described procedure, charging/discharging was executed while increasing the amperage sequentially to the rate of 0.05 C, 0.1 C, 0.2 C, 0.3 C, and 0.5 C. Upon each timing after charging and discharging, the secondary battery 100 was deactivated for 1 hour while being in the open circuit state. FIG. 4 shows measurement results.

### <Results and Discussion>

The secondary battery 100 is demanded to have a long service life and high rate characteristic. The evaluation criterion on the life is determined in accordance with the condition that the coulomb efficiency (ratio between discharge capacity and charging capacity) in the initial charging/discharging is equal to or higher than 70%. The evaluation criterion on the rate characteristic is determined in accordance with the condition that the capacity retention (discharge capacity/discharge capacity at 0.05 C rate×100) at 0.5 C rate (current value which allows completion of charging corresponding to the design capacity of the battery in 2 hours) is equal to or higher than 90%. The liquid volume in the electrode (vol %) is calculated based on porosity of the negative electrode 80.

FIG. 4 shows numerical data of results derived from the examples and the comparative examples. Values of the capacity retention at 0.5 C rate are only shown as the rate characteristic. As FIG. 4 clearly shows, Examples 1 to 30 exhibit superiority in the life and the rate characteristic to Comparative Examples 1 to 12. Detailed explanation will be further made as follows.

In the case of Comparative Example 9, the capacity retention is thought to be lowered owing to a side reaction between γ-butyrolactone and graphite. In Comparative Examples 10 and 11, each donor number of TMP and TEP is significantly large. The donor number of G4 as the glyme is approximately 17, and the donor number of G3 is approximately 15. Furthermore, the donor number of PC is approximately 15, and the donor number of EC is approximately 15. This indicates that the donor number of the ethereal solvent is substantially the same as that of the low-viscosity solvent. On the contrary, each donor number of TMP and TEP is approximately 23, which is about 50% larger than that of the glymes. As a result, the solvation structure of the solvation electrolyte salt and the ethereal solvent is collapsed, causing the capacity reduction.

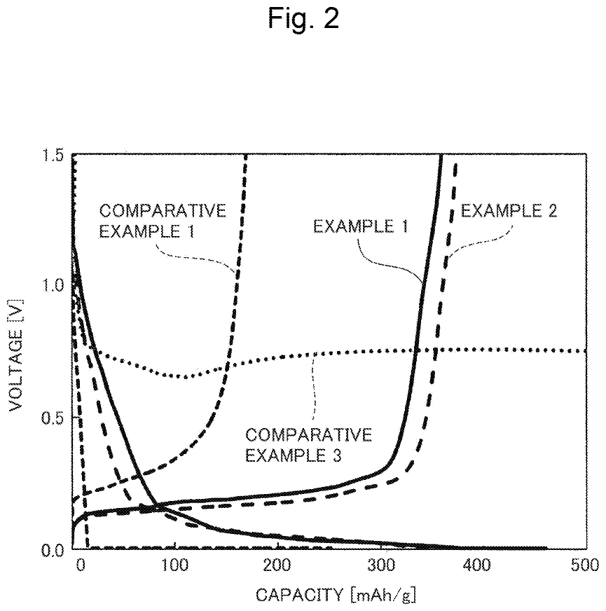

FIG. 2 shows charging/discharging curves each in the initial charging/discharging. In the example where tetraglyme, PC, and LiTFSI are mixed in a prescribed ratio, the resultant discharging capacity exceeds 90% of the design capacity, and the coulomb efficiency exceeds 70%. Meanwhile, in the comparative example using the mixed electrolytic solution of tetraglyme and LiTFSI, the discharging capacity measures only 40% of the design capacity, and the coulomb efficiency measures around 50%. The mixed electrolytic solution of PC and LiTFSI in Comparative Example 3 cannot charge the secondary battery owing to the side reaction with the PC, failing to obtain the desired discharging capacity. The results clearly show that the example has improved the discharging capacity and the coulomb efficiency of the secondary battery, indicating that the present invention is effective for improving the battery life.

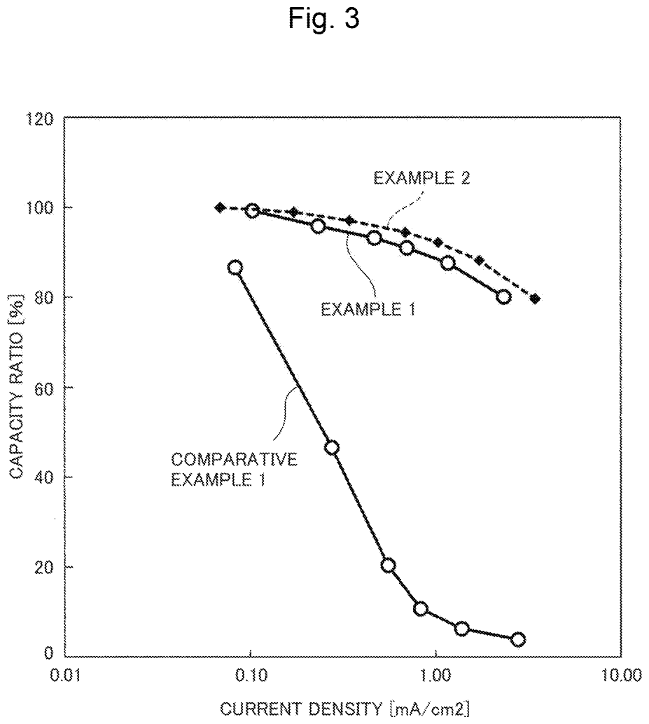

FIG. 3 shows the rate characteristics of the respective batteries. In the example where tetraglyme, PC, and LiTFSI are mixed in the prescribed ratio, the capacity retention at 1 C rate has reached 90% or higher, clearly showing improvement in the ion conductance. On the contrary, in Comparative Example 1 using the mixed electrolytic solution of tetraglyme and LiTFSI, the capacity retention at 1 C rate has reached only 20% or lower.

### REFERENCE SIGNS LIST

10: positive electrode current collector,

20: negative electrode current collector,

30: battery case,

40: positive electrode mixture layer,

50: semisolid electrolyte layer

60: negative electrode mixture layer,

70: positive electrode,

80: negative electrode,

100: secondary battery

1. A semisolid electrolytic solution comprising:
a solvation electrolyte salt;
an ethereal solvent for forming a solvation ion liquid together with the solvation electrolyte salt; and
a low-viscosity solvent, wherein:
a mixture molar ratio of the ethereal solvent to the solvation electrolyte salt is in a range from ≥0.5 to ≤1.5; and
a mixture molar ratio of the low-viscosity solvent to the solvation electrolyte salt is in a range from ≥4 to ≤16.

2. The semisolid electrolyte according to claim 1, wherein the mixture molar ratio of the low-viscosity solvent to the solvation electrolyte salt is in a range from ≥4 to ≤12.

3. The semisolid electrolyte according to claim 1, wherein the mixture molar ratio of the ethereal solvent to the solvation electrolyte salt is in a range from ≥0.5 to ≤1.2.

4. The semisolid electrolyte according to claim 1, further comprising an additive.

5. A semisolid electrolyte which contains the semisolid electrolytic solution according to claim 1 and particles, wherein the semisolid electrolytic solution is carried by the particles.

6. A semisolid electrolyte layer which contains the semisolid electrolyte according to claim 5, and a semisolid electrolyte binder.

7. An electrode having the semisolid electrolytic solution according to claim 1, wherein a content of the semisolid electrolytic solution in the electrode is in a range from ≥20 vol % to ≤40 vol %.

8. A secondary battery comprising a positive electrode, a negative electrode, and the semisolid electrolytic solution according to claim 1.

9. A secondary battery comprising a positive electrode, a negative electrode, and the semisolid electrolyte layer according to claim 6.
